(19) United States
(12) Patent Application Publication
(10) Pub. No.: US 2005/0269869 A1
(43) Pub. Date: Dec. 8, 2005

(54) Hydraulic brake system and method for influencing a hydraulic brake system

(76) Inventors: Stefan Lehenberger, Weitnau (DE); Frank Krueger, Hohnstein (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/143,644

(22) Filed: Jun. 3, 2005

(30) Foreign Application Priority Data
Jun. 4, 2004 (DE) 10 2004 027 508.4

(51) Int. Cl. B60T 13/18

(52) U.S. Cl. 303/11

(57) ABSTRACT

A hydraulic brake system for a vehicle, including at least one brake circuit which connects a master cylinder to at least one wheel brake, in which for each wheel brake, one inlet valve is provided, one pump, which pumps hydraulic fluid from a return line into a reservoir, and for each brake circuit present, there is one reservoir valve and one disconnection valve; the disconnection valve is located in the brake circuit between the master cylinder and the inlet valves; and the reservoir valve is located in a line from the reservoir to the brake circuit, and the line discharges into a line region of the brake circuit between the disconnection valve and the inlet valve.

### CROSS-REFERENCE TO RELATED APPLICATIONS

This application is based on German Patent Application 10 2004 027 508.4 filed Jun. 4, 2004, upon which priority is claimed.

### BACKGROUND OF THE INVENTION

1. Field of the Invention

The present invention relates to a hydraulic brake system for vehicles and to a method for influencing a brake system of this kind.

2. Description of the Prior Art

Hydraulic brake systems are known in various embodiments from the prior art. Often, such brake systems have additional regulating devices, such as ESP (electronic stability control) systems or TC (traction control) systems, for performing a driver-independent regulating intervention into the brake system in predetermined driving situations. In the known ESP systems a regulating intervention is effected, for instance such that, if it has been determined that a regulating intervention is necessary, a pump is operated in order to build up an appropriate pressure for a brake circuit and to perform appropriate regulating interventions at one wheel brake. In other words, in the known ESP systems, the pressure generation and the pressure application are done at the same instant. As a result, very stringent demands are made of the components of ESP systems, especially the drive motor, the pump elements, and the intake tract, and complicated damping provisions are made. The result is high costs for such ESP systems.

### SUMMARY AND ADVANTAGES OF THE INVENTION

The hydraulic brake system of the invention has the advantage over the prior art of having a central pressure supply in the form of a pressure reservoir. The central pressure supply can be connected to a brake circuit and disconnected via a reservoir valve. According to the invention, pressure generation is separate from both a storage and a pressure application. According to the invention, a master cylinder is provided, which is actuatable via a brake pedal. A brake circuit connects the master cylinder to at least one wheel brake, and per wheel brake, there are preferably at least one inlet valve and one outlet valve. A pump is furthermore provided, which pumps hydraulic fluid from a return line into the central pressure reservoir. Moreover, there are one reservoir valve and one disconnection valve per brake circuit. The disconnection valve is disposed in the brake circuit between the master cylinder and one inlet valve, and the reservoir valve is located in a line that leads from the reservoir to the inlet valve.

The master cylinder preferably has a brake booster, in particular a vacuum brake booster. As a result, the central reservoir of the invention can be used exclusively for regulating interventions by the regulation system.

In another preferred feature of the invention, a connecting line is provided between the central reservoir and the master cylinder. This connecting line supplies a hydraulic brake booster. The boosting of the brake force of the driver is thus done by means of pressure from the central reservoir. This is especially advantageous, since in diesel-powered vehicles and in engines with direct gasoline injection, considerable additional expense for creating the vacuum has previously been required for a vacuum brake booster. This makes it possible also to eliminate the problem that occurs in the case of vacuum supply in the prior art because of the fact that the vacuum supply is dependent on the load state of the engine, and in direct-injection diesel and gasoline engines the vacuum cannot be generated with the aid of the engine; instead, a separate additional device must be provided. The invention therefore has major potential cost savings for the brake booster as well as especially great advantages if a brake system is combined with a regulating system, such as ESP, TCS, ABS, and so forth.

The hydraulic brake system preferably includes two brake circuits in an X-type brake circuit distribution. Alternatively, two brake circuits in an H-type brake circuit distribution can be used. The distribution of the brake circuits will be selected depending on the type of drive system (front-wheel drive, rear-wheel drive, all-wheel drive), and on the existing regulating devices.

To have additional safety in the event of a leak from an outlet valve of the brake circuit, a safety valve is preferably located in a return line of the brake circuit. The safety valve is preferably located in a return line that is common to all the brake circuits, and especially preferably the safety valve is located hydraulically upstream of the pump, which aspirates out of the return line.

Preferably, one volume-detecting device is provided for each brake circuit in the brake system; this volume-detecting device detects a volume of the hydraulic fluid flowing out via an outlet valve and also pumps it back from the reservoir into the brake circuit. As a result, the volume used during certain regulating interventions is returned again, thus counteracting sagging of the brake pedal. The volume-detecting device in particular also includes software algorithms for determining volume.

Preferably, the pressure in the central reservoir is between 100 and 250×10⁵ Pa. Monitoring of the reservoir pressure is done by means of a pressure sensor, so that if the pressure undershoots a lower limit value, the pump is employed.

Preferably, a plurality of pumps for furnishing the reservoir pressure are connected parallel to one another. Especially preferably, the pumps are driven by a common drive mechanism. As a result, the costs can be reduced still further.

Magnet valves, which can be manufactured especially inexpensively, are preferably used as the valves.

In the method according to the invention for influencing a hydraulic brake system for a vehicle, having a central reservoir, the reservoir can be connected to and disconnected from an inlet valve of the brake circuit, via a reservoir valve. A master cylinder can be connected to an inlet valve of the brake circuit and disconnected from it via a disconnection valve. A regulating device determines a driver-independent regulating intervention into the brake system if predetermined parameters are met. If the regulating device determines that a regulating intervention must be performed, then the disconnection valve is instructed to interrupt the communication between the master cylinder and the inlet valve, and the reservoir valve is instructed to open the communication between the reservoir, in which hydraulic fluid that is under pressure is stored and the inlet valve so that a communication is established between the reservoir and the inlet valve of a brake circuit. As a result, the desired regulating intervention can be effected by means of the hydraulic fluid flowing out of the reservoir. Thus in the method of the invention, the pressure generation, which is effected by means of at least one pump, the pressure storage, and the pressure application are separate from one another.

In the method of the invention, boosting of a braking demand on the part of a driver is additionally effected by means of hydraulic fluid which is drawn from the central reservoir. As a result, a separate brake booster can be dispensed with.

The brake system of the invention is especially preferably employed in conjunction with ESP, TCS, and/or ABS systems. According to the invention, major cost reductions as well as improvements in performance and comfort can be attained for such systems. Compared with present electrohydraulic brake (EHB) systems, the invention makes a considerably improved emergency braking function possible.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a schematic view of a hydraulic circuit diagram of a brake system, in a first exemplary embodiment of the present invention; and

FIG. 2 is a schematic view of a hydraulic circuit diagram of a brake system, in a second exemplary embodiment of the present invention.

### DESCRIPTION OF THE PREFERRED EMBODIMENTS

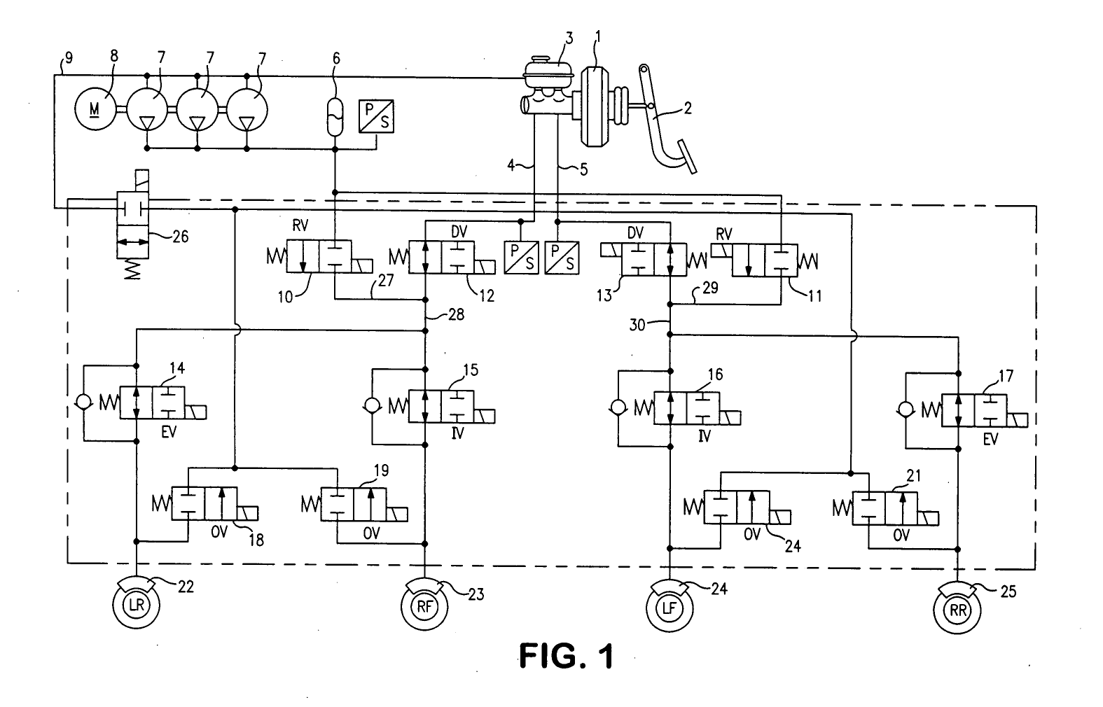

As shown in FIG. 1, the brake system of the invention includes a master cylinder 1, which is actuated by a driver by means of a brake pedal 2. A supply container 3 is provided on the master cylinder 1 in a known manner.

In the present exemplary embodiment, two brake circuits are provided, namely a first brake circuit 4 and a second brake circuit 5. The two brake circuits are disposed in a so-called X-type brake circuit arrangement, in which a right front wheel brake 23 (RF) and a left rear wheel brake 22 (LR) are disposed in the first brake circuit 4. A left front wheel brake 24 (LF) and a right rear wheel brake 25 (RR) are disposed in the second brake circuit 5.

In a known manner, for each wheel brake 22, 23, 24, 25, there are one inlet valve (IV) 14, 15, 16, 17 and one outlet valve (OV) 18, 19,20,21. The two brake circuits 4, 5 are united in a common return line 9, which leads to the supply container 3. A magnet valve 26 is also located in this common return line 9 and acts as a safety device, in the even that one of the outlet valves 18, 19, 20, 21 should leak.

As shown in FIG. 1, three pumps 7 are provided, which are driven by a common drive mechanism 8. The pumps 7 aspirate hydraulic fluid from the container 3 via the common return line 9 and pump the hydraulic fluid into a common reservoir 6. The reservoir 6 may be connected to the first brake circuit 4 via a reservoir valve 10 located in a line 27 and to the second brake circuit 5 via a reservoir valve 11 located in a line 29.

As can also be seen from FIG. 1, in each brake circuit there are also respective disconnection valves (DV) 12 and 13. More precisely, in the first brake circuit 4, one disconnection valve 12 is located between the master cylinder 1 and the inlet valves 14, 15, and in the second brake circuit 5, one disconnection valve 13 is located between the master cylinder 1 and the two inlet valves 16, 17.

As also shown in FIG. 1, pressure sensors (PS) are provided on the first and second brake circuits 4, 5 and on the reservoir 6, for delivering information about the pressure in each case to a regulating device, not shown.

If a normal braking event is initiated by the driver via the brake pedal 2, the brake system is in the position shown in FIG. 1. The braking demand is transmitted to the first and second brake circuits 4 and 5 via the master cylinder 1 in a known manner. The disconnection valves 12, 13 are in the open position then, and the reservoir valves 10 and 11 are in the closed position.

A description now follows for if a regulating intervention, for instance in an ESP system, is performed in which individual wheel brakes are meant to be used differently. The pumps 7 by this time have already been in operation long enough that a predetermined pressure exists in the reservoir 6. The pressure is preferably from 100 to 250×10⁵ Pa. If a regulating intervention of the ESP system is now to be performed, for instance at the first brake circuit 4, then the regulating device triggers the reservoir valve 10 and the disconnection valve 12 in such a way that the disconnection valve 12 moves to a closed state and the reservoir valve 10 changes to its opening state. As a result, the reservoir 6 communicates with the first brake circuit 4 downstream of the disconnection valve (see FIG. 1). The connecting line 27 between the reservoir 6 and the first brake circuit 4 discharges into a line portion 28 of the first brake circuit that is located between the disconnection valve 12 and the branch to the two inlet valves 14, 15. For the second brake circuit 5, the reservoir valve 11 is located in the line 29 between the reservoir 6 and a line portion 30 between the disconnection valve 13 and the inlet valves 16, 17. Depending on the position of the inlet valves 14, 15, the hydraulic fluid, which is under pressure, can now be delivered from the reservoir 6 to the appropriate wheel brake 22 or 23, via the reservoir valve 10 and the line 27, and a corresponding braking event can be initiated. Once the regulating intervention is ended, the reservoir valve 10 is closed again, and the opened inlet valves 14, 15 are closed, and the outlet valves 18 and 19 are moreover opened, so that the hydraulic fluid that is under pressure can be returned to the common return line 9. The disconnection valve 12 is likewise returned to its opened position in the process.

The brake system of the invention thus has the advantage that pressure generation, pressure storage and pressure application can be separated from one another not only structurally but also chronologically. A common pressure supply for both brake circuits 4, 5 via the common central reservoir 6 is possible. The reservoir 6 may for instance be a gas pressure reservoir, or the like. As a result of the aforementioned separation, a sturdier and simpler construction with less likelihood of failure and producing less noise can be used for generating pressure, rather than the complicated pressure generating devices necessary in the prior art, which have to furnish the requisite operating pressure with a minimal response time.

As a result of the pressure application from the reservoir 6, a more-active pressure buildup with markedly enhanced dynamics can be done according to the invention. In other words, the response times for the regulating intervention can be shortened. Because of the use of simpler components, the brake system of the invention moreover not only has enhanced reliability but also a more-economical construction. In particular, regulating devices can be operated more reliably at extremely low temperatures, which has been problematic until now in the prior art. Another advantage of the brake system of the invention is that even if the regulating device fails, the full braking function can be maintained. To that end, the control of the pressure supply is designed to be simple and fail-safe, for instance separately from the control of the valves for the pressure modulation.

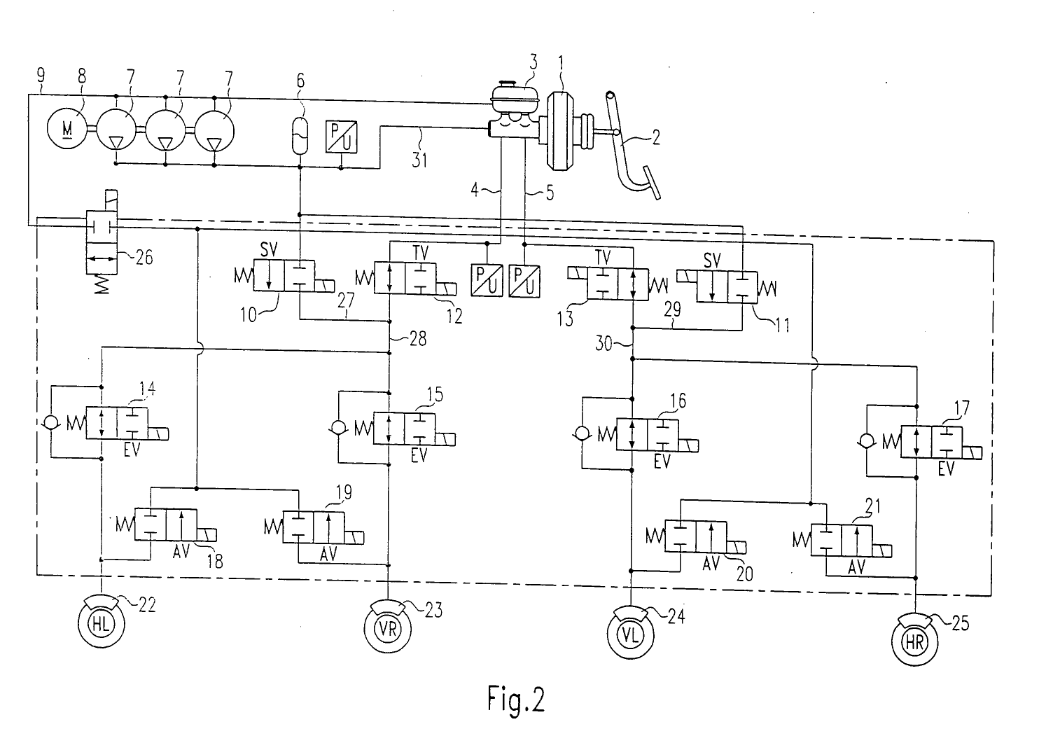

A brake system will now be described in conjunction with FIG. 2 in terms of a second exemplary embodiment of the present invention. Elements that are the same or functionally the same are identified by the same reference numerals as in the first exemplary embodiment.

The brake system in the second exemplary embodiment has essentially the same functions as in the first exemplary embodiment. Unlike the first exemplary embodiment, however, in the second exemplary embodiment a connecting line 31 is also provided between the reservoir 6 and the master cylinder 1 (see FIG. 2). Because of the connecting line 31, a vacuum brake booster can be dispensed with in the master cylinder 1, since upon an actuation of the brake pedal 2 by the driver, the braking demand can be boosted by hydraulic fluid, which is under pressure, from the reservoir 6 via the connecting line 31.

Thus in the second exemplary embodiment, a hydraulic brake system is used which is supplied from the same reservoir 6 for the regulating intervention.

As a result, a brake booster of reduced structural size can be realized, and moreover the brake system can be used in vehicles independently of the type of engine. That is, in engines with direct diesel or gasoline injection, the additional expense for creating a vacuum for a brake booster can be dispensed with. This has major cost advantages, compared with the prior art. Otherwise, the brake system shown in FIG. 2 in terms of the second exemplary embodiment has the same advantages as the first exemplary embodiment with regard to the regulating intervention, so that reference may be made to the description of the first exemplary embodiment.

The foregoing relates to preferred exemplary embodiments of the invention, it being understood that other variants and embodiments thereof are possible within the spirit and scope of the invention, the latter being defined by the appended claims.

1. A hydraulic brake system for a vehicle, including at least one brake circuit (4, 5) which connects a master cylinder (1) to at least one wheel brake (22, 23, 24, 25), the brake system comprising
one inlet valve (14, 15, 16, 17) for each wheel brake,
a return line (9) for returning hydraulic fluid from each wheel brake to the master cylinder,
a hydraulic fluid reservoir (6),
at least one pump which pumps hydraulic fluid from the return line (9) into the reservoir,
one reservoir valve (10, 11) and one disconnection valve (12, 13) connected in each brake circuit,
the disconnection valve being located in the brake circuit (4, 5) between the master cylinder (1) and the inlet valves (14, 15, 16, 17), and
a line (27, 29) extending from the reservoir (6) and discharging into a line region (28, 30) of the brake circuit between the disconnection valve (12, 13) and the inlet valve (14, 15, 16, 17),
the reservoir valve (10, 11) being located in the line (27, 29).

2. The hydraulic brake system as recited in claim 1, wherein the master cylinder (1) comprises a brake booster.

3. The hydraulic brake system as recited in claim 1, further comprising by a connecting line (31) between the reservoir (6) and the master cylinder (1), for furnishing a hydraulic brake booster.

4. The hydraulic brake system as recited in claim 1, wherein the hydraulic brake system comprises two brake circuits (4, 5) in an X-type brake circuit distribution or two brake circuits in an H-type brake circuit distribution.

5. The hydraulic brake system as recited in claim 2, wherein the hydraulic brake system comprises two brake circuits (4, 5) in an X-type brake circuit distribution or two brake circuits in an H-type brake circuit distribution.

6. The hydraulic brake system as recited in claim 3, wherein the hydraulic brake system comprises two brake circuits (4, 5) in an X-type brake circuit distribution or two brake circuits in an H-type brake circuit distribution.

7. The hydraulic brake system as recited in claim 1, further comprising a safety valve (26), which is located in the return line (9) of the brake circuit (4, 5).

8. The hydraulic brake system as recited in claim 2, further comprising a safety valve (26), which is located in the return line (9) of the brake circuit (4, 5).

9. The hydraulic brake system as recited in claim 3, further comprising a safety valve (26), which is located in the return line (9) of the brake circuit (4, 5).

10. The hydraulic brake system as recited in claim 4, further comprising a safety valve (26), which is located in the return line (9) of the brake circuit (4, 5).

11. The hydraulic brake system as recited in claim 1, further comprising an outlet valve (18, 19, 20, 21) and a volume-detecting device for detecting a volume flowing out of the outlet valve.

12. The hydraulic brake system as recited in claim 2, further comprising an outlet valve (18, 19, 20, 21) and a volume-detecting device for detecting a volume flowing out of the outlet valve.

13. The hydraulic brake system as recited in claim 3, further comprising an outlet valve (18, 19, 20, 21) and a volume-detecting device for detecting a volume flowing out of the outlet valve.

14. The hydraulic brake system as recited in claim 4, further comprising an outlet valve (18, 19, 20, 21) and a volume-detecting device for detecting a volume flowing out of the outlet valve.

15. The hydraulic brake system as recited in claim 7, further comprising an outlet valve (18, 19, 20, 21) and a volume-detecting device for detecting a volume flowing out of the outlet valve.

16. The hydraulic brake system as recited in claim 1, wherein the pressure in the reservoir (6) is between 100 and 250×10⁵ Pa.

17. The hydraulic brake system as recited in claim 1, wherein a plurality of pumps (7) are connected parallel to one another, for pumping fluid from the return line (9) into the reservoir (6).

18. A method for influencing a hydraulic brake system for a vehicle, wherein the hydraulic brake system includes a reservoir (6), which can be connected to and disconnected from an inlet valve (14, 15, 16, 17) of a brake circuit (4, 5) via a reservoir valve (10, 11), and a master cylinder (1), which can be connected to and disconnected from an inlet valve (14, 15, 16, 17) of the brake circuit (4, 5) via a disconnection valve (12, 13), and includes a regulating device for determining a driver-independent regulating intervention into the brake system, the method comprising
effecting the driver-independent regulating intervention by furnishing hydraulic fluid that is under pressure from the reservoir (6), utilizing the disconnection valve to break the connection between the master cylinder (1) and the inlet valve (14, 15, 16, 17), and utilizing the reservoir valve (10, 11) to establish a connection between the reservoir (6) and the inlet valve.

19. The method as recited in claim 18, wherein boosting of an actuation of the brake pedal (2) by the driver is effected by means of hydraulic fluid from the reservoir (6).

20. A vehicle having a hydraulic brake system as defined by claim 1.
